(19) United States
(12) Patent Application Publication
(10) Pub. No.: US 2019/0256059 A1
(43) Pub. Date: Aug. 22, 2019

(54) Trailer Support System and Method

(71) Applicant: Martin Ruppert, Dover, PA (US)

(72) Inventor: Martin Ruppert, Dover, PA (US)

(21) Appl. No.: 16/278,256

(22) Filed: Feb. 18, 2019

Related U.S. Application Data
(60) Provisional application No. 62/632,135, filed on Feb. 19, 2018.

(51) Int. Cl. B60S 9/04; B60S 9/22

(52) U.S. Cl. CPC B60S 9/04; B60D 1/66; B60S 9/22

(57) ABSTRACT

A trailer support system and method for supporting a trailer. The trailer support system includes two telescopic support leg assemblies attached to two portions of the trailer, thereby supporting the trailer and preventing the trailer from rocking or tipping during loading and unloading of the trailer. A vertical position of each of the two support leg assemblies is adjustable, thereby enabling a user to raise or lower the support leg assemblies for towing or loading and unloading the trailer, respectively.

### CROSS REFERENCE TO RELATED APPLICATIONS

This application claims priority under 35 U.S.C. § 119(e) to U.S. Provisional Application No. 62/632,135 filed on Feb. 19, 2018. The above identified patent application is incorporated by reference herein in its entirety to provide continuity of disclosure.

### BACKGROUND OF THE INVENTION

The present invention relates to a trailer support system and a method of supporting a trailer while the trailer is not connected to a vehicle, for example, during loading and unloading of the trailer, using the trailer support system.

Many towing trailers have only a single pair of wheels. To load or unload a trailer having only two wheels, the trailer usually must be attached to a vehicle, such as a truck. In this manner, the trailer is stabilized by the two wheels and a third point of contact with the truck, and the trailer does not tip or see-saw about an axle of the two wheels during loading or unloading. However, it is often desirable to load or unload a two-wheeled trailer without connecting the trailer to the truck. For example, the truck may be unavailable during loading and unloading, or stabilization of a loaded trailer may be needed after disconnecting the truck from the loaded trailer, to prevent shifting or loss of items in the trailer following disconnection.

Therefore, there is a need in the art for a trailer support system and method of supporting a two-wheeled trailer when the trailer is disconnected from a vehicle that utilizes the trailer support system. The present invention addresses this unmet need.

Devices have been disclosed in the art that relate to trailer supports. These include devices that have been patented and published in patent application publications. These devices are often inconvenient to use and require careful application to avoid an injury of a user. In view of the devices disclosed in the art, it is submitted that there is a need in the art for an improvement to existing trailer support systems. In view of the present disclosure, it is submitted that the present invention substantially diverges in structural and functional elements from devices in the art, and the present invention substantially fulfills an unmet need in the art.

### SUMMARY OF THE INVENTION

In view of the disadvantages inherent in the known types of trailer support systems in the art, the present invention provides an improved trailer support system, wherein the same can be utilized for supporting a trailer for loading or unloading when the trailer is not connected to a vehicle or another stabilizing structure.

It is therefore an object of the present invention to provide a trailer support system.

Another object of the present invention is to provide a method of supporting a trailer using the trailer support system.

Another object of the present invention is to provide a trailer support system that may be readily manufactured from materials that permit relative economy and are commensurate with durability.

In one aspect, the invention provides a trailer support system, comprising a first support leg assembly comprising a first locking pin, a first bracket attachable to a first portion of a trailer, and a first support leg slidably disposable within the first bracket, such that an aperture selected from a plurality of apertures of the first support leg is alignable with apertures on the first bracket. The first support leg is securable within the first bracket by aligning the aperture selected from the plurality of apertures of the first support leg with the apertures on the first bracket and placing the first locking pin through the apertures so aligned.

In another aspect, the invention provides the first support leg assembly in combination with a second support leg assembly comprising a second locking pin, a second bracket attachable to a second portion of a trailer, and a second support leg slidably disposable within the second bracket, such that an aperture selected from a plurality of apertures of the second support leg is alignable with apertures on the second bracket. The second support leg is securable within the second bracket by aligning the aperture selected from the plurality of apertures of the second support leg with the apertures on the second bracket and placing the second locking pin through the apertures so aligned.

Generally, the first support leg assembly and the second support leg assembly are adjustable, such that either or both support leg assemblies can be prepared for towing by sliding the support legs within the brackets to upper positions and securing the support legs at the upper positions by inserting the locking pins through the apertures so aligned. Each of the two support leg assemblies can also be prepared for supporting the trailer during loading or unloading by sliding the support legs within the brackets to lower positions and securing the support legs at the lower positions by inserting the locking pins through the apertures so aligned. In this manner, the system is designed to be permanently or semi-permanently attached to the trailer at the brackets, increasing convenience and safety while using the trailer and the system.

Generally, the first support leg assembly is identical to the second support leg assembly, and the primary difference between embodiments using one support leg assembly and two support leg assemblies is the number and positions of the support leg assemblies. Nonetheless, advantages may be gained from using two support leg assemblies instead of one support leg assembly, including but not limited to an increased stability of the trailer when using the system to support the trailer. Therefore, in embodiments in which two support leg assemblies are used instead of one support leg assembly, it is beneficial to place the two support leg assemblies on opposite sides of the trailer, for example, a left side and a right side of the trailer, to maximize the stability of the trailer when using the system to support the trailer. The increased stability reduces a chance of the trailer tipping or see-sawing about an axle of the two wheels of the trailer during loading or unloading the trailer. In some embodiments, the two support leg assemblies are placed forward of an axle of the trailer, and in other embodiments, the two support leg assemblies are placed rearward of the axle of the trailer.

In another aspect, the invention provides a method of supporting a trailer, comprising attaching the first bracket to the first portion of a trailer, slidably disposing the first support leg within the first bracket, and securing the first support leg within the first bracket with the first locking pin. In another aspect, the invention provides a method of supporting a trailer using the first bracket, first support leg, and first locking pin, in combination with a second bracket, second support leg, and second locking pin.

Generally, the method comprises attaching the first bracket to the first portion of the trailer, slidably disposing the first support leg within the first bracket, and securing the first support leg within the first bracket with the first locking pin, as well as attaching the second bracket to the second portion of the trailer, slidably disposing the second support leg within the second bracket, and securing the second support leg within the second bracket with the second locking pin. To support the trailer, the support legs are each slid and secured into lower positions, such that the support legs contact a ground of an environment. In this manner, the trailer is stabilized because a weight of the trailer is applied to the support legs, which are in contact with the ground. To tow the trailer, the support legs are each slid and secured into upper positions, such that the support legs do not contact the ground. In this manner, the trailer is prepared for towing because the support legs are not in contact with the ground.

Generally, the invention provides the system comprising the first support leg assembly, optionally combined with the second support leg assembly, for supporting the trailer when the trailer is not mounted to a trailer hitch or is otherwise not sufficiently supported when not being towed. Each of the support leg assemblies comprises the bracket configured to be permanently or semi-permanently mounted to the first portion or the second portion of the trailer, such that the brackets are each configured to slidably receive the support leg therethrough. The support legs comprise a plurality of apertures along a length of each of the support legs, and each of the brackets also comprises a forward and a rearward aperture. In this manner, the apertures of the support legs are alignable with the apertures of the brackets, and a vertical position of each of the support legs may be secured by placing the locking pin through the apertures so aligned.

Generally, the vertical positions of the support legs may be adjusted by removing the locking pins and sliding the legs upward or downward. The vertical positions of the support legs may be secured in place at any selection of the plurality of apertures on the support leg by re-inserting the locking pins through the apertures so aligned. In this manner, the support legs may be raised to an upward position, such that a bottom end of the support legs is suspended above the ground for towing or maneuvering the trailer, or the support legs may be lowered to a downward position, such that the bottom ends of the support legs contact the ground for loading or unloading the trailer.

Other objects, features and advantages of the present invention will become apparent from the following detailed description taken in conjunction with the accompanying drawings.

### BRIEF DESCRIPTIONS OF THE DRAWINGS

Although the characteristic features of the invention will be particularly pointed out in the claims, the invention itself and manners in which it may be made and used may be better understood after a review of the following description, taken in connection with the accompanying drawings, wherein like numeral annotations are provided throughout.

FIG. 1 depicts a left elevation view of a first support leg assembly mounted to a left side of a trailer.

FIG. 2 depicts a rear elevation view of the first support leg assembly mounted to the left side of the trailer.

FIG. 3 depicts an exploded perspective view of the first support leg assembly.

FIG. 4 depicts a right elevation view of a second support leg assembly mounted to a right side of the trailer.

FIG. 5 depicts a rear elevation view of the second support leg assembly mounted to the right side of the trailer.

FIG. 6 depicts a rear elevation view of the first support leg assembly mounted to the left side of the trailer, and the second support leg assembly mounted to the right side of the trailer.

### DETAILED DESCRIPTION OF THE INVENTION

Reference is made herein to the attached drawings. Like reference numerals are used throughout the drawings to depict like or similar elements of the invention. The figures are intended for representative purposes only and should not be considered limiting in any respect.

Reference is now made to the drawings, which depict one or more exemplary embodiments of the invention.

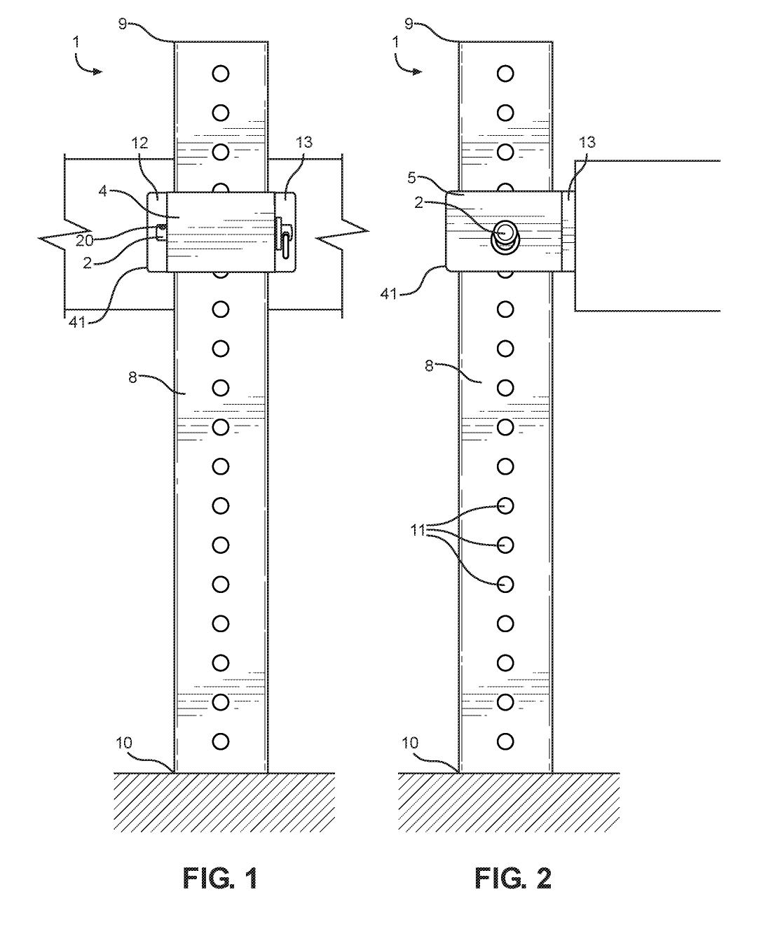

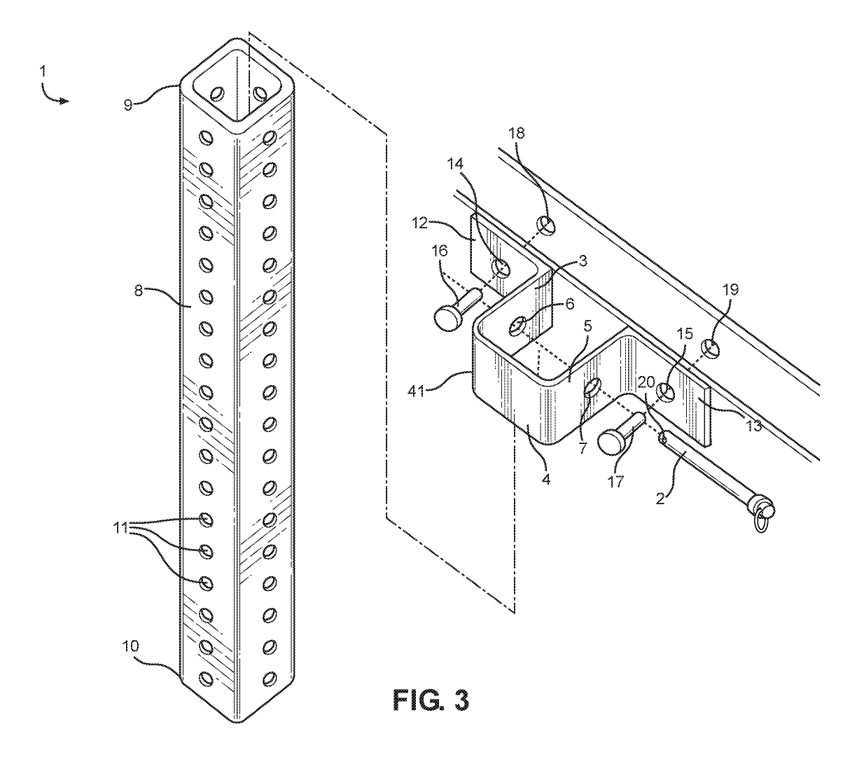

Referring now to FIGS. 1, 2, and 3, there are depicted a left elevation view, a rear elevation view, and an exploded perspective view, respectively, of a first support leg assembly mounted (FIGS. 1, and 2) or adjacent (FIG. 3) to a left side of a trailer. The first support leg assembly 1 comprises a first locking pin 2, a first bracket 41 comprising a first bracket forward sidewall 3, a first bracket outer sidewall 4, and a first bracket rearward sidewall 5. The first bracket forward sidewall 3 and the first bracket rearward sidewall 5 each comprises an aperture thereon (6 and 7, respectively), configured to receive the first locking pin 2 therethrough. The first bracket forward sidewall 3 and the first bracket rearward sidewall 5 are attachable to a first portion of a trailer.

The first support leg assembly 1 also comprises a first support leg 8 comprising an upper end 9 connected to a lower end 10, and a plurality of apertures 11 arranged longitudinally along a length of the first support leg 8, such that each of the plurality of apertures 11 extends fully through the first support leg 8 and is configured to receive the first locking pin 2 therethrough. The first support leg 8 is slidably disposable within the first bracket 41 such that an aperture selected from the plurality of apertures 11 of the first support leg 8 is alignable with the first bracket forward sidewall aperture 6 and the first bracket rearward sidewall aperture 7.

The first support leg 8 is securable within the first bracket 41 by aligning the aperture selected from the plurality of apertures 11 of the first support leg 8 with the first bracket forward sidewall aperture 6 and the first bracket rearward sidewall aperture 7, and placing the first locking pin 2 through the first bracket forward sidewall aperture 6, the first bracket rearward sidewall aperture 7, and the aperture selected from the plurality of apertures 11 of the first support leg 8. In this manner, the first bracket 41 is stationary with respect to the first portion of the trailer, and the first support leg 8 may be slidable with respect to the first portion of the trailer. The first support leg 8 may be secured in place, thereby preventing a vertical sliding of the first support leg 8 within the first bracket 41, by placing the first locking pin 2 through the apertures so aligned. A number of apertures, a frequency of apertures, a periodicity of apertures, a percentage of the length of the first support leg 8 having apertures, and a distance between any two apertures selected from the plurality of apertures 11 of the first support leg 8 are configured to enable support of a range of trailers of different heights using the present invention.

In some embodiments, the first bracket forward sidewall 3 is perpendicularly attached to the first bracket outer sidewall 4, and the first bracket outer sidewall 4 is perpendicularly attached to the first bracket rearward sidewall 5. The first bracket forward sidewall 3 and the first bracket rearward sidewall 5 are parallel to each other and extend equidistantly from the first bracket outer sidewall 4 toward the first portion of the trailer. In this manner, the first bracket outer sidewall 4 is parallel or nearly parallel to a surface of the first portion of the trailer, thereby facilitating construction or manufacturing of the first support leg assembly 1 by any number of suitable methods. To further improve ease of manufacturing, in some embodiments, a width of the first bracket forward sidewall 3, a width of the first bracket outer sidewall 4, and a width of the first bracket rearward sidewall 5 are equal, and the first support leg 8 has a square cross section. Further, in some embodiments, the first locking pin 2 is cylindrical, each aperture of the plurality of apertures 11 of the first support leg 8 is cylindrical, and the first bracket forward sidewall aperture 6 and the first bracket rearward sidewall aperture 7 are cylindrical. Further, in some embodiments, the first support leg 8 is hollow to minimize an amount of starting material required for practicing the present invention.

In some embodiments, the first bracket forward sidewall 3 is connected to a first bracket forward mounting member 12, and the first bracket rearward sidewall 5 is connected to a first bracket rearward mounting member 13. The first bracket forward mounting member 12 comprises an aperture 14 therethrough, and the first bracket rearward mounting member 13 comprises an aperture 15 therethrough. The first bracket forward mounting member aperture 14 and the first bracket rearward mounting member aperture 15 are configured to align with a first bracket forward mounting member receiving aperture 18 and a first bracket rearward mounting member receiving aperture 19, respectively. After the mounting member apertures 14 and 15 are aligned with the receiving apertures 18 and 19 located on the first portion of the trailer, a first bracket forward fastener 16 and a first bracket rearward fastener 17 are inserted through the apertures so aligned, as depicted in FIG. 3, to attach the first bracket 41 to the first portion of the trailer. In some embodiments, the first locking pin 2 comprises a first locking pin aperture 20, configured to receive and secure a first locking pin fastener therethrough, to prevent the first locking pin 2 from falling out of the first bracket 41 during towing or loading and unloading the trailer.

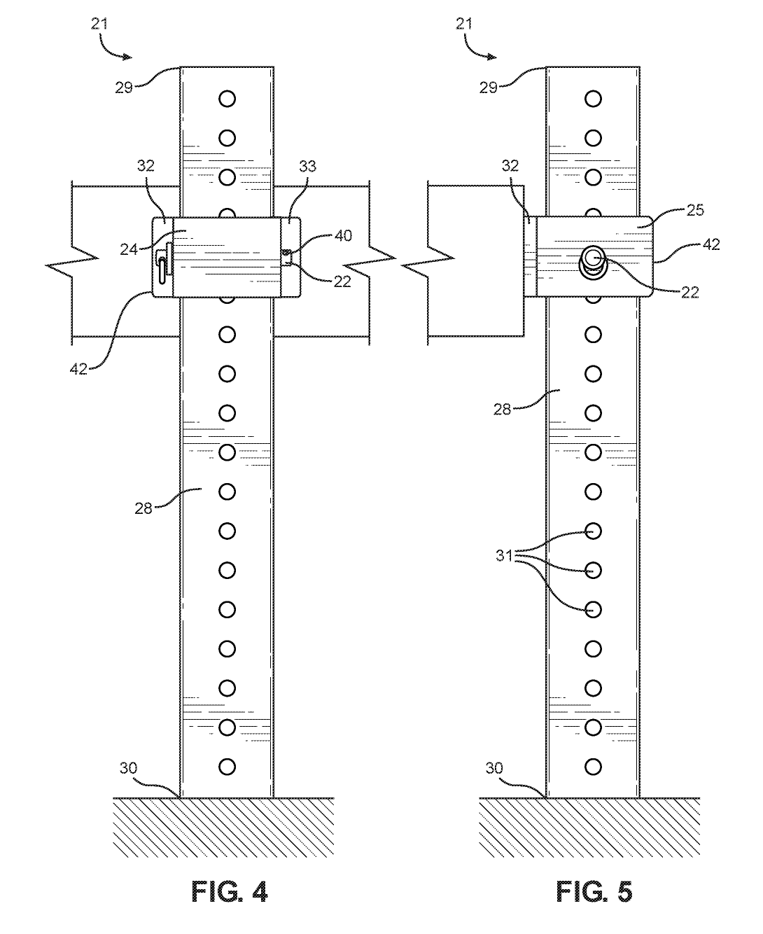

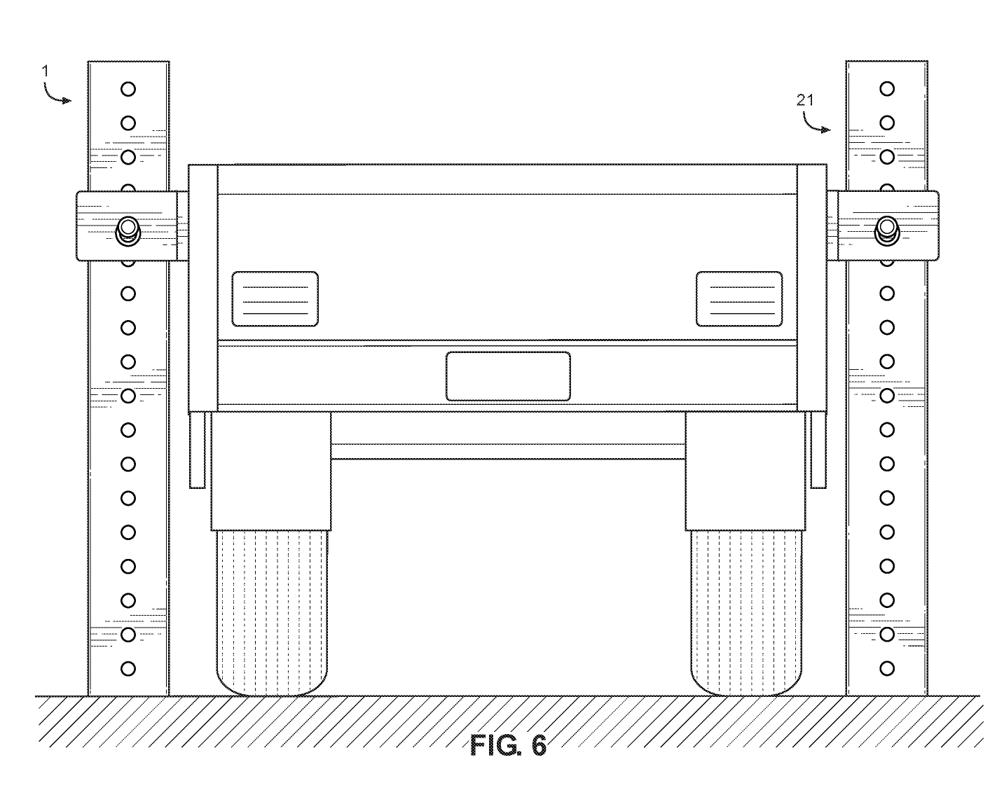

Referring now to FIGS. 4 and 5, there are depicted a right elevation view and a rear elevation view, respectively, of a second support leg assembly mounted to a right side of the trailer. Generally, the second support leg assembly 21 comprises all the features of the first support leg assembly 1. The second support leg assembly 21 comprises a second locking pin 22, a second bracket 42 comprising a second bracket forward sidewall, a second bracket outer sidewall 24, and a second bracket rearward sidewall 25. The second bracket forward sidewall and the second bracket rearward sidewall 25 each comprises an aperture thereon, configured to receive the second locking pin 22 therethrough. The second bracket forward sidewall and the second bracket rearward sidewall 25 are attachable to a second portion of a trailer.

The second support leg assembly 21 also comprises a second support leg 28 comprising an upper end 29 rigidly connected to a lower end 30, and a plurality of apertures 31 arranged longitudinally along a length of the second support leg 28, such that each of the plurality of apertures 31 extends fully through the second support leg 28 and is configured to receive the second locking pin 22 therethrough. The second support leg 28 is slidably disposable within the second bracket 42 such that an aperture selected from the plurality of apertures 31 of the second support leg 28 is alignable with the second bracket forward sidewall aperture and the second bracket rearward sidewall aperture.

The second support leg 28 is securable within the second bracket 42 by aligning the aperture selected from the plurality of apertures 31 of the second support leg 28 with the second bracket forward sidewall aperture and the second bracket rearward sidewall aperture, and placing the second locking pin 22 through the second bracket forward sidewall aperture, the second bracket rearward sidewall aperture, and the aperture selected from the plurality of apertures 31 of the second support leg 28. In this manner, the second bracket 42 is stationary with respect to the second portion of the trailer, and the second support leg 28 may be slidable with respect to the second portion of the trailer. The second support leg 28 may be secured in place, thereby preventing a vertical sliding of the second support leg 28 within the second bracket 42, by placing the second locking pin 22 through the apertures so aligned. A number of apertures, a frequency of apertures, a periodicity of apertures, a percentage of the length of the second support leg 28 having apertures, and a distance between any two apertures selected from the plurality of apertures 31 of the second support leg 28 are configured to enable support of a range of trailers of different heights using the present invention.

In some embodiments, the second bracket forward sidewall is perpendicularly attached to the second bracket outer sidewall 24, and the second bracket outer sidewall 24 is perpendicularly attached to the second bracket rearward sidewall 25. The second bracket forward sidewall and the second bracket rearward sidewall 25 are parallel to each other and extend equidistantly from the second bracket outer sidewall 24 toward the second portion of the trailer. In this manner, the second bracket outer sidewall 24 is parallel or nearly parallel to a surface of the second portion of the trailer, thereby facilitating construction or manufacturing of the second support leg assembly 21 by any number of suitable methods. To further improve ease of manufacturing, in some embodiments, a width of the second bracket forward sidewall, a width of the second bracket outer sidewall 24, and a width of the second bracket rearward sidewall 25 are equal, and the second support leg 28 has a square cross section. Further, in some embodiments, the second locking pin 22 is cylindrical, each aperture of the plurality of apertures 31 of the second support leg 28 is cylindrical, and the second bracket forward sidewall aperture and the second bracket rearward sidewall aperture are cylindrical. Further, in some embodiments, the second support leg 28 is hollow to minimize an amount of starting material required for practicing the present invention.

In some embodiments, the second bracket forward sidewall is connected to a second bracket forward mounting member 32, and the second bracket rearward sidewall 25 is connected to a second bracket rearward mounting member 33. The second bracket forward mounting member 32 comprises an aperture therethrough, and the second bracket rearward mounting member 33 comprises an aperture therethrough. The second bracket forward mounting member aperture and the second bracket rearward mounting member aperture are configured to align with a second bracket forward mounting member receiving aperture and a second bracket rearward mounting member receiving aperture, respectively. After the mounting member apertures are aligned with the receiving apertures located on the second portion of the trailer, a second bracket forward fastener and a second bracket rearward fastener are inserted through the apertures so aligned, to attach the second bracket 42 to the second portion of the trailer. In some embodiments, the second locking pin 22 comprises a second locking pin aperture 40, configured to receive and secure a second locking pin fastener therethrough, to prevent the second locking pin 22 from falling out of the second bracket 42 during towing or loading and unloading the trailer.

Referring now to FIG. 6, there is depicted a rear elevation view of the first support leg assembly mounted to the left side of the trailer, and the second support leg assembly mounted to the right side of the trailer. The first support leg assembly 1 and the second support leg assembly 21 are depicted in a lowered position, such that the support legs of the assemblies 1 and 21 contact the ground. In this position, the trailer is configured for loading or unloading. To prepare the assemblies 1 and 21 for towing the trailer, the support legs of the assemblies 1 and 21 are raised upward and secured in place, thereby preventing the support legs from contacting the ground, as described elsewhere herein.

In some embodiments, the first support leg assembly 1 is mounted or attached to the left side of the trailer, and the second support leg assembly 21 is mounted or attached to the right side of the trailer, thereby creating four contact points between the trailer and the ground to maximize a stability of the trailer. In some embodiments, the first support leg assembly 1 is mounted at a first position forward of an axle of the trailer, and the second support leg assembly 21 is mounted at a second position forward of the axle of the trailer. In some embodiments, the first support leg assembly 1 is mounted at a first position rearward of the axle of the trailer, and the second support leg assembly 21 is mounted at a second position rearward of the axle of the trailer. Generally, the two assemblies 1 and 21 are equidistant from the axle of the trailer. As a distance between the axle and the two assemblies 1 and 21 increases, the stability of the trailer is increased, as would be understood by an artisan.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

I claim:

1) A trailer support system, comprising:
a first support leg assembly, comprising:
a first locking pin;
a first bracket having a first bracket forward sidewall, a first bracket outer sidewall, and a first bracket rearward sidewall, wherein the first bracket forward sidewall and the first bracket rearward sidewall each comprises an aperture thereon configured to receive the first locking pin therethrough, wherein the first bracket forward sidewall and the first bracket rearward sidewall are attachable to a first portion of a trailer;
a first support leg having an upper end connected to a lower end, and a plurality of apertures arranged longitudinally along a length of the first support leg, wherein each of the plurality of apertures extends fully through the first support leg and is configured to receive the first locking pin therethrough;
wherein the first support leg is slidably disposable within the first bracket such that an aperture selected from the plurality of apertures of the first support leg is alignable with the first bracket forward sidewall aperture and the first bracket rearward sidewall aperture;
wherein the first support leg is securable within the first bracket by aligning the aperture selected from the plurality of apertures of the first support leg with the first bracket forward sidewall aperture and the first bracket rearward sidewall aperture, and placing the first locking pin through the first bracket forward sidewall aperture, the first bracket rearward sidewall aperture, and the aperture selected from the plurality of apertures of the first support leg.

2) The trailer support system of claim 1, comprising a second support leg assembly, comprising:
a second locking pin;
a second bracket having a second bracket forward sidewall, a second bracket outer sidewall, and a second bracket rearward sidewall, wherein the second bracket forward sidewall and the second bracket rearward sidewall each comprises an aperture thereon configured to receive the second locking pin therethrough, wherein the second bracket forward sidewall and the second bracket rearward sidewall are attachable to a second portion of the trailer;
a second support leg having an upper end connected to a lower end, and a plurality of apertures arranged longitudinally along a length of the second support leg, wherein each of the plurality of apertures extends fully through the second support leg and is configured to receive the second locking pin therethrough;
wherein the second support leg is slidably disposable within the second bracket such that an aperture selected from the plurality of apertures of the second support leg is alignable with the second bracket forward sidewall aperture and the second bracket rearward sidewall aperture;
wherein the second support leg is securable within the second bracket by aligning the aperture selected from the plurality of apertures of the second support leg with the second bracket forward sidewall aperture and the second bracket rearward sidewall aperture, and placing the second locking pin through the second bracket forward sidewall aperture, the second bracket rearward sidewall aperture, and the aperture selected from the plurality of apertures of the second support leg.

3) The trailer support system of claim 2, wherein the first bracket forward sidewall is connected to a first bracket forward mounting member, wherein the first bracket rearward sidewall is connected to a first bracket rearward mounting member, wherein the second bracket forward sidewall is connected to a second bracket forward mounting member, wherein the second bracket rearward sidewall is connected to a second bracket rearward mounting member.

4) The trailer support system of claim 2, wherein the first bracket forward sidewall is perpendicularly attached to the first bracket outer sidewall, wherein the first bracket outer sidewall is perpendicularly attached to the first bracket rearward sidewall, wherein the first bracket forward sidewall and the first bracket rearward sidewall are parallel to each other and extend equidistantly from the first bracket outer sidewall toward the first portion of the trailer, wherein the second bracket forward sidewall is perpendicularly attached to the second bracket outer sidewall, wherein the second bracket outer sidewall is perpendicularly attached to the second bracket rearward sidewall, wherein the second bracket forward sidewall and the second bracket rearward sidewall are parallel to each other and extend equidistantly from the second bracket outer sidewall toward the second portion of the trailer.

5) The trailer support system of claim 4, wherein a width of the first bracket forward sidewall, a width of the first bracket outer sidewall, and a width of the first bracket rearward sidewall are equal, wherein the first support leg has a square cross section, wherein a width of the second bracket forward sidewall, a width of the second bracket outer sidewall, and a width of the second bracket rearward sidewall are equal, wherein the second support leg has a square cross section.

6) The trailer support system of claim 2, wherein the first locking pin is cylindrical, wherein each aperture of the plurality of apertures of the first support leg is cylindrical, wherein the first bracket forward sidewall aperture and the first bracket rearward sidewall aperture are cylindrical, wherein the second locking pin is cylindrical, wherein each aperture of the plurality of apertures of the second support leg is cylindrical, wherein the second bracket forward sidewall aperture and the second bracket rearward sidewall aperture are cylindrical.

7) The trailer support system of claim 2, wherein the first support leg is hollow, wherein the second support leg is hollow.

8) The trailer support system of claim 2, wherein the first bracket forward sidewall and the first bracket rearward sidewall are attached to the first portion of the trailer, wherein the second bracket forward sidewall and the second bracket rearward sidewall are attached to the second portion of the trailer, wherein the first portion of the trailer and the second portion of the trailer are equidistant from an axle of the trailer.

9) The trailer support system of claim 8, wherein the first portion of the trailer and the second portion of the trailer are each forward of the axle of the trailer.

10) The trailer support system of claim 8, wherein the first portion of the trailer and the second portion of the trailer are each rearward of the axle of the trailer.

11) A method of supporting a trailer, comprising:
attaching a first bracket, having a first bracket forward sidewall having an aperture thereon, a first bracket outer sidewall, and a first bracket rearward sidewall having an aperture thereon, to a first portion of the trailer;
sliding a first support leg, having an upper end connected to a lower end, and a plurality of apertures arranged longitudinally along a length of the first support leg and extended fully through the first support leg, within the first bracket;
aligning an aperture selected from the plurality of apertures of the first support leg with the first bracket forward sidewall aperture and the first bracket rearward sidewall aperture;
securing the first support leg within the first bracket by placing a first locking pin through the first bracket forward sidewall aperture, the first bracket rearward sidewall aperture, and the aperture selected from the plurality of apertures of the first support leg.

12) The method of claim 11, comprising:
attaching a second bracket, having a second bracket forward sidewall having an aperture thereon, a second bracket outer sidewall, and a second bracket rearward sidewall having an aperture thereon, to a second portion of a trailer;
sliding a second support leg, having an upper end connected to a lower end, and a plurality of apertures arranged longitudinally along a length of the second support leg and extended fully through the second support leg, within the second bracket;
aligning an aperture selected from the plurality of apertures of the second support leg with the second bracket forward sidewall aperture and the second bracket rearward sidewall aperture;
securing the second support leg within the second bracket by placing a second locking pin through the second bracket forward sidewall aperture, the second bracket rearward sidewall aperture, and the aperture selected from the plurality of apertures of the second support leg.

13) The method of claim 12, wherein the first bracket forward sidewall is connected to a first bracket forward mounting member, wherein the first bracket rearward sidewall is connected to a first bracket rearward mounting member, wherein the second bracket forward sidewall is connected to a second bracket forward mounting member, wherein the second bracket rearward sidewall is connected to a second bracket rearward mounting member;
wherein attaching the first bracket to the first portion of the trailer includes attaching the first bracket forward mounting member and the first bracket rearward mounting member to the first portion of the trailer;
wherein attaching the second bracket to the second portion of the trailer includes attaching the second bracket forward mounting member and the second bracket rearward mounting member to the second portion of the trailer.

14) The method of claim 12, wherein the first bracket forward sidewall is perpendicularly attached to the first bracket outer sidewall, wherein the first bracket outer sidewall is perpendicularly attached to the first bracket rearward sidewall, wherein the first bracket forward sidewall and the first bracket rearward sidewall are parallel to each other and extend equidistantly from the first bracket outer sidewall toward the first portion of the trailer, wherein the second bracket forward sidewall is perpendicularly attached to the second bracket outer sidewall, wherein the second bracket outer sidewall is perpendicularly attached to the second bracket rearward sidewall, wherein the second bracket forward sidewall and the second bracket rearward sidewall are parallel to each other and extend equidistantly from the second bracket outer sidewall toward the second portion of the trailer.

15) The method of claim 14, wherein a width of the first bracket forward sidewall, a width of the first bracket outer sidewall, and a width of the first bracket rearward sidewall are equal, wherein the first support leg has a square cross section, wherein a width of the second bracket forward sidewall, a width of the second bracket outer sidewall, and a width of the second bracket rearward sidewall are equal, wherein the second support leg has a square cross section.

16) The method of claim 12, wherein the first locking pin is cylindrical, wherein each aperture of the plurality of apertures of the first support leg is cylindrical, wherein the first bracket forward sidewall aperture and the first bracket rearward sidewall aperture are cylindrical, wherein the second locking pin is cylindrical, wherein each aperture of the plurality of apertures of the second support leg is cylindrical, wherein the second bracket forward sidewall aperture and the second bracket rearward sidewall aperture are cylindrical.

17) The method of claim 12, wherein the first support leg is hollow, wherein the second support leg is hollow.

18) The method of claim 12, wherein the first bracket forward sidewall and the first bracket rearward sidewall are attached to the first portion of the trailer, wherein the second bracket forward sidewall and the second bracket rearward sidewall are attached to the second portion of the trailer, wherein the first portion of the trailer and the second portion of the trailer are equidistant from an axle of the trailer.

19) The method of claim 18, wherein the first portion of the trailer and the second portion of the trailer are each forward of the axle of the trailer.

20) The method of claim 18, wherein the first portion of the trailer and the second portion of the trailer are each rearward of the axle of the trailer.
